(19) United States
(12) Patent Application Publication
(10) Pub. No.: US 2003/0176594 A1
(43) Pub. Date: Sep. 18, 2003

(54) Chain extension process

(76) Inventors: Jacobus A. Loontjens, Meerssen (NL); Bartholomeus J.M. Plum, Ulestraten (NL)

Correspondence Address: PILLSBURY WINTHROP, LLP, P.O. BOX 10500, MCLEAN, VA, 22102, US

(21) Appl. No.: 10/221,016

(22) PCT Filed: Mar. 9, 2001
(86) PCT No.: PCT/NL01/00199

(51) Int. Cl. C08F 20/00

(52) U.S. Cl. 525/437

(57) ABSTRACT

The invention relates to a process for preparing a high-molecular polymer by contacting in a melt a difunctional lowermolecular polymer whose functional end groups are —OH or —NH₂ groups with carbonylbislactamate, characterized in that the melt also contains an acid or a base as a catalyst. If the difunctional polymer contains a —COOH group, it is preferred for the melt also to contain a bisoxazine or a bisoxazoline.

The invention relates to a process for preparing a high-molecular weight polymer by contacting in a melt a difunctional polymer having a lower molecular weight whose end functional groups are —OH or —NH₂ groups with a carbonylbislactamate (CBL) with the following formula:

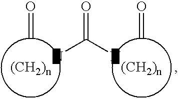

wherein n is an integer from 3 to 15. Preferably the carbonylbislactamate is carbonylbiscaprolactamate (CBC), with n=5.

A similar process is disclosed in WO 98/47940. WO 98/47940 describes a process for preparing a high-molecular polyamide by contacting polyamide having a lower molecular weight in the melt with carbonylbiscaprolactamate (CBC).

A drawback of that process is that the reaction proceeds comparatively slowly.

The object of the invention is to provide a process that does not have the aforementioned drawback or has the aforementioned drawback to a lesser extent.

This object is achieved by the melt also containing an acid or a base. The acid or base has the function of a catalyst.

This ensures that the reaction proceeds more rapidly, as is apparent from the fact that the viscosity increases much more rapidly with catalyst than without catalyst. This can be established from for example the increase in the torque of a Brabender in which a blend of a difunctional polymer and CBL is kneaded optionally in the presence of an acid or a base.

Acids that are suitable for use as a catalyst for chain extension in the presence of CBL are LiX, Sb₂O₃, GeO₂ and As₂O₃, BX₃, MgX₂, BiX₃, SnX₄, SbX₅, FeX₃, GeX₄, GaX₃, HgX₂, ZnX₂, AlX₃, TiX₄, MnX₂, ZrX₄, R₄NX, R₄PX, HX, where X=I, Br, Cl, F, OR and R=alkyl or aryl. Brpnstedt acids such as H₂SO₄, HNO₃, HX, H₃PO₄, H₃PO₃, RH₂PO₂, RH₂PO₃, R[(CO)OH]ₙ, with n=1-6 are also suitable.

Bases that are suitable for use as a catalyst for chain extension in the presence of CBC are Li-versetate, Zn acetylacetonate (acac),M(OH)ₙ, (RO)ₙM (M=alkali or earth alkali, R=alkyl with C₁-C₂₀ or aryl), NRₙH₄₋ₙOH (R=alkyl with C₁-C₂₀ or aryl), triamines such as triethylamine, tributylamine, trihexylamine, trioctylamine and cyclic amines such as diazobicyclo[2,2,2]octane (DABCO), dimethylaminopyridine (DMAP), guanidine, morfoline, dibutyl tin dilaurate (DBTDL), dibutyl tin bis(2-ethylhexanoate), dibutyl tin dibutylate, dibutyl tin dimethylate, dibutyl tin dioctanoate.

It is preferred for the catalyst to be a Lewis acid or a Lewis base. This ensures that the time needed for curing is even shorter.

It is preferred for the Lewis acid or base to be tetraalkoxytitanate, Zr(OR)₄, Li versetate, ZnAcAc in which the alkoxy group is for example a butoxy group or an isopropoxy group.

The amount of carbonylbiscaprolactamate used in the process of the invention may vary between wide limits. As a rule, at least about 0.1% by weight relative to the functional polymer is needed in order to have an appreciable effect. Amounts in excess of 3% by weight do not normally result in any further increase in molecular weight.

One skilled in the art will generally adjust the amount of carbonylbislactamate to suit the number of available functional groups and the viscosity increase that needs to result from the increased molecular weight. He/she will normally determine the most optimum amount for his/her situation through simple experiment.

A difunctional polymer here and hereinafter means a polymer with two functional groups per molecule consisting of an —OH group or an —NH₂ group.

Examples of such polymers are polyamides, polyesters, polycarbonates and polyetherpolyols.

The process of the invention can in principle be applied for all types of polyamide. These include at least the aliphatic polyamides, for example polyamide-4, polyamide-6, polyamide-8, polyamide-4,6, polyamide-6,6, polyamide-6,10, polyamides derived from an aliphatic diamine and an aromatic dicarboxylic acid, for example polyamide-4,T, polyamide-6,T, polyamide-4,I, where T stands for terephthalate and I for isophthalate, copolyamides of linear polyamides and copolyamides of an aliphatic and a partially aromatic polyamide, for example polyamide 6/6,T and 6/6,I.

Suitable polyesters for which the process of the invention may be applied are at least polyesters derived from aliphatic dicarboxylic acids and diols, polyesters of aliphatic and cycloaliphatic diols and aromatic dicarboxylic acids, copolyesters that are partly aliphatic and partly aromatic and polyesters which contain units that are derived from cycloaliphatic dicarboxylic acids. Examples hereof are polybutylene adipate, polymethylene terephthalate polyethylene terephthalate, polyethylene naphthalate, polybutylene terephthalate, copolyesters of polybutylene adipate and polybutylene terephthalate and the polyesters derived from butane diol and cyclohexanedicarboxylic acid

The polyetherpolyols, for which the process of the invention may be applied are polyols, which possess a oxyalkylene structure, composed of a oxyalkylene group, with 1-10 carbon atoms an oxygen atom as repeating unit and which preferably are a diol. Examples of polyetherpolyols are polyoxymethylene, polyethylene glycol, polypropylene glycol, polytetramethylene glycol, polyheptamethylene glycol, polyhexamethylene glycol and polydecamethylene glycol.

The process of the invention can readily be carried out using the customary techniques and melt blending equipment, for example by blending the lower molecular polyamide and the carbonylbislactamate and optionally other additives in the solid phase, for example in a tumble dryer, whereupon the obtained blend is melted in a customary melt blender, for example a Haake kneader, a Brabender blender or a twin-screw or double-screw extruder. The various components may also be added to the blending equipment separately.

The carbonylbislactamate and catalyst may also be added to a polymer product stream of a functional polymer having a lower molecular weight as it exits from a polymerization reactor in which this polymer was polymerized.

The polymerization process may be operated batch-wise or continuously. In the former case, the residence time in the reactor can be shortened and so productivity can be increased and the postcondensation step can be omitted.

In the process of the invention, CBL reacts solely with the —NH₂ groups or the —OH functional groups of the functional polymers. Functional polymers that also possess —COOH functionality react with either the —OH functional groups or the —NH₂ functional groups. If —COOH functionality is present in the melt, it is preferred not only for CBL and the catalyst but also a bisoxazine or a bisoxazoline to be present in the process of the invention. This ensures that the reaction proceeds even more rapidly.

It is preferred for the bisoxazoline to be 1,4-phenylenebisoxazoline.

The invention will be elucidated on the bases of the following examples.

### EXAMPLE 1

CBC is added to grinded and dried PET with 2 —OH end groups and a relative viscosity of η=1,59 in a molair ratio of 1:2 (CBC:PET). 1 wt % of catalyst with respect to the amount of CBC was added. All the PET samples were extruded in a laboratory extruder for 15 gram samples at 280° with a residence time of 4 minutes. The resulting viscosities are given in table 1.

TABLE 1

| Acid/Base | Relative viscosity |
|---|---|
| Para toluene sulfonic acid | 1.77 |
| MgBr₂ | 1.77 |
| NaOC₂H₅ | 1.78 |
| DBTDL | 1.79 |
| SnCl₄ | 1.81 |
| VO(iOPr)₃ | 1.81 |
| DABCO | 1.83 |
| LiOCH₃ | 1.83 |
| LiBr | 1.83 |
| Lil | 1.83 |
| Zn(acac)₂ | 1.84 |
| LiCl | 1.87 |
| Zr(acac)₄ | 1.87 |
| Zr(IV)(OC₄ H₉)₄ | 1.88 |
| Li-versetate | 1.94 |

iOPr = isopropoxy

### Comparative Experiment A

Example 1 was repeated without adding any catalyst. The relative viscosity increased from 1.59 to 1.76

From these experiments it can be concluded that the addition of acids and bases in a process for preparing a high-molecular weight polymer by contacting in a melt a difunctional low-molecular weight polymer with a carbonylbislactamate results in a faster increase in molecular weight and thus chain extension than without an acid or a base.

It may further be concluded that preferably lithium chloride, zirconium(IV)butoxide, zirconium acetylacetonate or lithium versetate are added.

1. Process for preparing a high-molecular polymer by contacting in a melt a difunctional lowermolecular polymer whose end functional groups are —OH or —NH₂ groups with a carbonylbislactamate with the following formula: 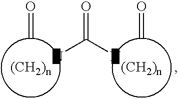
wherein n is an integer from 3 to 15, characterized in that the melt also contains an acid or a base.

2. Process according to claim 1, in which the catalyst is a Lewis acid or a Lewis base.

3. Process according to claim 1 or claim 2, in which the carbonylbislactamate is carbonylbiscaprolactamate.

4. Process according to any one of claims 1-3, in which the difunctional polymer also contains a —COOH group and in that a bisoxazine or a bisoxazoline is also present in the melt.
